(19) United States
(12) Patent Application Publication
(10) Pub. No.: US 2015/0057419 A1
(43) Pub. Date: Feb. 26, 2015

(54) FREE RADICAL AND CONTROLLED RADICAL POLYMERIZATION PROCESSES USING AZIDE RADICAL INITIATORS

(71) Applicant: UNIVERSITY OF CONNECTICUT, Farmington, CT (US)

(72) Inventor: Alexandru D. ASANDEI, Vernon, CT (US)

(21) Appl. No.: 14/465,084

(22) Filed: Aug. 21, 2014

Related U.S. Application Data
(60) Provisional application No. 61/869,231, filed on Aug. 23, 2013.

(51) Int. Cl. C08F 114/22

(52) U.S. Cl. CPC C08F 114/22
USPC 526/217; 526/236; 526/255

(57) ABSTRACT

A process is described comprising polymerizing at least one unsaturated monomer (e.g., fluorine substituted alkene monomer) in the presence of an azide radical initiator and a solvent, under reaction conditions and for a time sufficient to polymerize the at least one unsaturated monomer to form a polymer. The present disclosure provides a method for the synthesis of polymers with 100% azide chain end functionality, for living/controlled radical polymerization of unsaturated monomers (e.g., fluorine substituted alkene monomers) and for the synthesis of complex polymer architectures, using azide click reactions.

### RELATED APPLICATION

This application claims the benefit of U.S. Provisional Application Ser. No. 61/869,231, filed on Aug. 23, 2013, which is incorporated herein by reference in its entirety.

### BACKGROUND

1. Field of the Disclosure

This disclosure relates to a process for free radical and for living or controlled radical polymerization of alkene monomers (including fluorine substituted alkene monomers), particularly the use of azide radical initiators in the living or controlled radical polymerization of alkene monomers. Unique polymeric materials are provided using azide initiators for radical polymerizations and chain end derivatization.

2. Discussion of the Background Art

Conventional chain polymerization of vinyl monomers usually consists of three main elemental reaction steps: initiation, propagation, and termination. Initiation stage involves creation of an active center from an initiator. Propagation involves growth of the polymer chain by sequential addition of monomer to the active center. Termination (including irreversible chain transfer) refers to termination of the growth of the polymer chain. Owing to the presence of termination and poorly controlled transfer reactions, conventional chain polymerization typically yields a poorly controlled polymer in terms of molecular weight and polydispersity which control the polymer properties. Moreover, conventional chain polymerization processes mostly result in polymers with simple architectures such as linear homopolymer and linear random copolymer.

Living/controlled polymerization is characterized by the absence or dramatic suppression of any kinds of termination or side reactions which might break propagation reactions. The most important feature of living polymerization is that one may control the polymerization process to design the molecular structural parameters of the polymer. Additional polymerization systems where the termination reactions are, while still present, negligible compared to propagation reaction are known in the art. As structural control can generally still be well achieved with such processes, they are thus often termed “living” or controlled polymerization.

In living or controlled polymerization, as only initiation and propagation mainly contribute to the formation of polymer, molecular weight can be predetermined by means of the ratio of consumed monomer to the concentration of the initiator used and will increase linearly with conversion. The ratio of weight average molecular weight to number average molecular weight, i.e., molecular weight distribution (Mw/Mn), may accordingly be as low as 1.0, and the polymers have well defined chain ends. Moreover, polymers with specifically desired structures and architectures can be purposely produced. In terms of topology, such structures and architectures may include linear, star, comb, hyperbranched, dendritic, cyclic, network, and the like. In terms of sequence/composition distribution, such structures and architectures may include homopolymer, random copolymer, block copolymer, graft copolymer, gradient copolymer, tapered copolymer, periodic copolymer, alternating copolymer, and the like. In terms of functionalization, such structures and architectures may include telechlics, macromonomer, labeled polymer, and the like.

Living polymerization processes have been successfully used to produce numerous polymeric materials which have been found to be useful in many applications. However, many living polymerization processes have not found wide acceptance in industrial commercialization, mainly due to high cost to industrially implement these processes. Thus, searching for practical living polymerization processes is a challenge in the field of polymer chemistry and materials.

Additionally, as (co)polymers of main chain fluorinated monomers (e.g., vinylidene fluoride (VDF), hexafluoropropene, tetrafluoroethylene, trifluorochloroethylene, and the like) are industrially significant, the study of their controlled radical polymerization and the synthesis of complex polymer architectures thereby derived, would be desirable. However, such polymerizations are challenging on laboratory scale, as bp_{VDF}=−83° C. Thus, telo/polymerizations are carried out at T>80-150° C. and require high-pressure metal reactors.

Kinetic studies of VDF polymerizations involve many one-data-point experiments as direct sampling is difficult. This is very time-consuming and expensive due to the typical lab unavailability of a large number of costly metal reactors, which moreover require tens of grams of monomer. The development of methods that would allow small scale (e.g., a few grams) VDF polymerizations at ambient temperature in inexpensive, low pressure glass tubes, would be highly desirable, since the methods could easily be adapted for fast screening of a wide range of polymerization and of reaction conditions, and could also take advantage of photochemistry. The development of such methods would also be useful on a large scale, for example, in an industrial setting. Conventional initiating systems such as peroxides or redox systems do not initiate the polymerization of VDF at ambient or room temperature.

It would be desirable to provide a method for living polymerization of alkene and fluoroalkene monomers which provides a high level of macromolecular control over the polymerization process and which leads to uniform and more controllable polymeric products. It would be especially desirable to provide such a living polymerization process with existing facility, which enables the use of a wide variety of readily available starting materials. It would be further desirable to provide a method that would allow small scale (e.g., a few grams) VDF polymerizations at ambient temperature in inexpensive, low pressure glass tubes, and also large scale VDF polymerizations, for example, in industrial settings.

Block copolymers are widely used in everyday applications and are a high volume as well as a high value, general and specialized materials. Thus, their controlled synthesis via inexpensive, air and water tolerant means would also bring a significant industrial benefit.

Block copolymers can be synthesized by sequential monomer addition in a living/controlled polymerization, if both monomers polymerize via the same mechanism (e.g. methyl methacrylate and styrene), and the chain ends of the first block are still reactive. However, when block copolymers based on monomers which polymerize by dissimilar mechanisms (such as radical polymerization and cationic or anionic ring opening polymerization e.g. poly(vinyl acetate)-block-polycaprolactone)) are desired, they can be synthesized by either a coupling reaction of appropriately functionalized chain ends of the respective polymers, or by the conversion of the functional chain end group of the first block, into a functionality that can initiate the polymerization of the second block. However, unless both polymer chains are 100% functionalized at their chain ends, and the coupling reaction is 100% effective, the resulting block will always be contaminated with non-block, unfunctionalized polymeric precursors, the separation of which is extremely difficult and impractical.

The most efficient coupling reactions known in organic and polymer chemistry reactions is based on the [3+2] cycloaddition of azides with alkynes, the so-called “click” reaction. The introduction of the azide functionality at the chain end of a polymer can conceivably be performed by a nucleophilic substitution of a halide chain end using e.g. NaN₃ as a nucleophile. However, this requires the prerequisite of 100% prior halide chain end functionalization of the first block, and moreover, 100% yield in the conversion of the halide to the azide. Moreover, while atom transfer radical polymerizations (ATRP) can provide halide terminated polymers, such chemistry cannot provide 100% halide chain end functionalization. Moreover, for many polymers, including fluorinated ones, the halide to azide chain end conversion will be very sluggish and incomplete. Thus, both of the above requirements are very hard to accomplish in practice on polymer substrates. While an initiator containing an azide functionality and an alkyl halide could conceivably be utilized to initiate a polymerization by ATRP, such initiator structures are cost prohibitive and impractical.

However, if the azide functionality, i.e., the azide radical, would be able to add directly to an alkene monomer and initiate its polymerization, all chains would contain an azide, i.e., such polymer would exhibit 100% azide chain end functionality.

### SUMMARY OF THE DISCLOSURE

This disclosure relates in part to a process comprising polymerizing at least one unsaturated monomer, e.g., alkene monomer, in the presence of an azide radical initiator and optionally a solvent. The process is conducted under reaction conditions and for a time sufficient to polymerize the at least one unsaturated monomer to form a polymer.

This disclosure also relates in part to a process comprising polymerizing at least one unsaturated monomer, e.g., alkene monomer, in the presence of an azide radical initiator, a solvent, and an iodine source. The process is conducted under reaction conditions and for a time sufficient to controllably polymerize the at least one unsaturated monomer to form a polymer.

This disclosure yet further relates in part to polymers, random copolymers and block copolymers produced by the above described processes.

The disclosure describes azide radical initiators for the low temperature, room temperature and high temperature radical redox, thermal and photochemical polymerization of alkenes, and especially including fluorine substituted alkenes. The radical redox, thermal or photopolymerization can also be carried out at higher or lower temperatures than room temperature. The present disclosure also provides a method for living polymerization of alkene monomers, which provides a high level of macromolecular control over the polymerization process and which leads to uniform and controllable polymeric products. Azide derivatives are a unique methodology to achieve initiation of the polymerization process, either thermally or preferably under visible or ultraviolet initiation.

In accordance with this disclosure, a unique method of radical initiation involving the in situ generation of the azide N₃. radical is provided. This allows the unprecedented 100% chain end functionalization of any alkene polymer, and thus enables the “click” chemistry with any correspondingly functionalized alkyne polymer/surface/nanotube/etc, or any other chemical structures, towards the unique synthesis of block copolymers and other compositions of matter.

The method of this disclosure is a universal method, applicable to all classes of radically polymerizable alkenes. By contrast, current technology involves chain end derivatization (e.g. PSt-Br to PSt-N₃) which is inefficient and moreover requires the use of halide functionalized precursors. Moreover, the resulting chain end functionality, never reaches 100%, as required for efficient block synthesis.

In accordance with this disclosure, the method enables significant benefits and advantages and is very efficient and inexpensive, as it precludes expensive controlled polymerization and derivatization steps. Moreover, the additional benefit of quantitative generation of “click reaction” precursors is a significant advantage over all known polymer click coupling methodologies which require additional purification steps. Thus, by contrast, the materials produced in accordance with this disclosure are pure blocks, (or other architectures) uncontaminated with homopolymers.

Further objects, features and advantages of the present disclosure will be understood by reference to the following drawings and detailed description.

### BRIEF DESCRIPTION OF THE DRAWINGS

FIG. 1 depicts a reaction scheme for the formation of azide radicals by the reaction of an azide derivative with a hypervalent iodide compound and for the direct initiation of the polymerization of an alkene from the azide radicals.

FIG. 2 depicts a Click reaction coupling scheme exemplified for PVDF.

FIG. 3 depicts a proton-NMR spectrum of 4 PVDF samples, using hypervalent iodides carboxylates (HVI) such as (CX₃COO)₂I^{III}Ph, (X═H, ((diacetoxy)iodo)benzene, HVI; X═F, bis(trifluoroacetoxy)iodo)benzene, FHVI): HVI initiator without NaN₃ (a), using FHVI initiator without NaN₃ (b), HVI initiator with NaN₃ (c), FHVI initiator with NaN₃ (d), [VDF]/[F/HVI]=50/1(a)(b), [VDF]/[F/HVI]/[NaN₃]=50/1/2(c)(d). All 4 reactions were conducted under visible light for 24 hours, T=40° C., VDF/DMC=1.1 g/3 mL.

FIG. 4 depicts fluorine-NMR spectrum of the same 4 PVDF samples in FIG. 3, using HVI initiator without NaN₃ (a), using FHVI initiator without NaN₃ (b), HVI initiator with NaN₃ (c), FHVI initiator with NaN₃ (d). [VDF]/[F/HVI]=50/1(a)(b), [VDF]/[F/HVI]/[NaN₃]=50/112(c)(d). All 4 reactions were conducted under light bulb for 24 hours, T=40° C., VDF/DMC=1.1 g/3 mL.

FIG. 5 depicts azide initiated VDF polymerizations: time effect (Exp. 1-3); [I]/[NaN₃] ratio effect (Exp. 3-7); light effect (Exp. 5-11) [VDF]/[DMC]=1.65 g/3 mL, T=400° C. under light bulb, unless otherwise noted.

FIG. 6 graphically depicts the effect of light on the dependence of conversion (a), on the [NaN₃]/[Hypervalent Iodine] ratio (triangles=under light, squares=in the dark).

FIG. 7 graphically depicts the effect of light on the dependence of Mn (b) on the [NaN₃]/[Hypervalent Iodine] ratio (triangles=under light, squares=in the dark).

FIG. 8 graphically depicts the effect of light on the dependence of PDI (c) on the [NaN₃]/[Hypervalent Iodine] ratio (triangles=under light, squares=in the dark).

FIG. 9 depicts proposed mechanism of the azide-enabled VDF FRP and iodine degenerative transfer (IDT) with external and in situ generated CTAs, using cerium ammonium nitrate and sodium azide for the generation of the azide radical.

FIG. 10 lists experiments of azide initiated VDF polymerizations: control experiments (exp. 1-3), initiator effect (exp. 7-9), and DP effect (exp. 9-10). T=40° C./dark, Solvent=DMC. ^{a)}NaNO₃ used instead of NaN₃.

FIG. 11 lists experiments of solvent effect in azide initiated VDF polymerizations. T=40° C./dark.

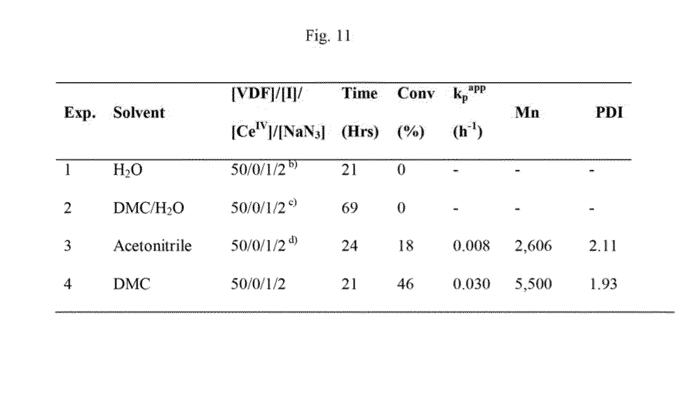

FIG. 12 depicts 500 MHz ¹H-NMR (acetone-d₆) spectra of PVDF-N₃ obtained from azide initiated VDF-FRP. See FIG. 10 exp 5.

FIG. 13 depicts 400 MHz ¹⁹F-NMR (acetone-d₆) spectra of same sample from FIG. 12.—c2′ is the -PVDF-CF₂—CH₂—CH₂—CF₂—N₃.

FIG. 14 depicts 2D heteronuclear H, F—COSY of N₃-PVDF-N₃ obtained from azide initiated VDF-FRP. See FIG. 10 exp 5.

FIG. 15 depicts 500 MHz ¹H-NMR (acetone-d₆) spectra of PVDF initiated from (a) azide alone (b) azide in the presence of CHI₃ and (c) azide in the presence of I—(CF₂)₆—I.

FIG. 16 graphically depicts the dependence of Mₙ, M_{w}/Mₙ on conversion and kinetics in azide-initiated FRP of VDF: [VDF]/[(NH₄)₂Ce(NO₃)₆]/[NaN₃]=50/1/2 (▪) and 100/1/2 ( [symbol] ).

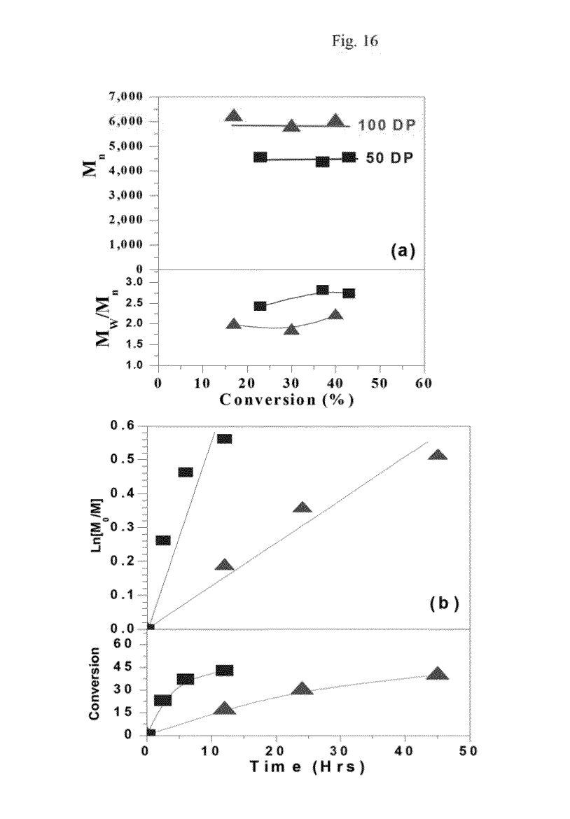

FIG. 17 graphically depicts the dependence of Mₙ, M_{w}/Mₙ on conversion and kinetics in azide-enabled CRP of VDF at 40° C. in the Dark. [VDF]/[I—(CF₂)₆—I]/[(NH₄)₂Ce(NO₃)₆]/[NaN₃]=50/1/1/2 (◯), 100/1/1/2 ( [symbol] ) and [VDF]/[I₂]/[(NH₄)₂Ce(NO₃)₆]/[NaN₃]=50/0.2/1/1.2 [symbol] [VDF]/[“N₃I”]/[(NH₄)₂Ce(NO₃)₆]/[NaN₃]=125/1/1.5/2( [symbol] ).

FIG. 18 depicts illustrative Click chemistry reactions.

FIG. 19 graphically depicts 500 MHz ¹H-NMR (acetone-d) spectra of (a) N₃-PVDF-N₃ starting material (Mₙ=4,500, PDI=2.73) (b) PVDF-triazole and (c) PCL-b-PVDF-b-PCL block copolymer (Mₙ=15,400, PDI=1.49).

FIG. 20 graphically depicts (a) GPC traces of PVDF-b-PCL. (b) DSC heating and cooling cycle of PVDF-b-PCL.

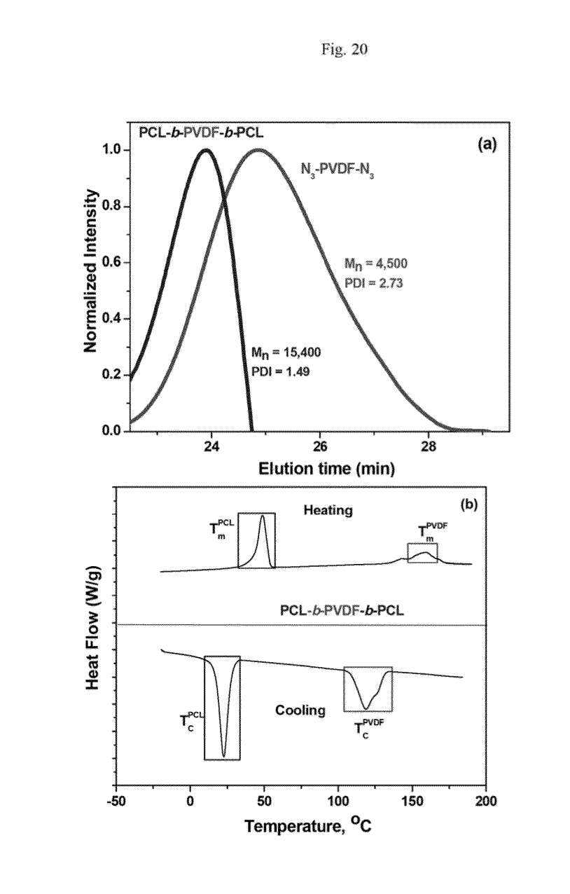

### DETAILED DESCRIPTION OF THE PREFERRED EMBODIMENT

As used herein, the term “polymerization” includes oligomerization, cooligomerization, polymerization, copolymerization and block copolymerization. The copolymerization can be block or random.

As used herein, the term “polymer” includes oligomer, cooligomer, polymer and copolymer. The copolymer can be block or random.

As used herein, the term “polymer” includes molecules of varying sizes having at least two repeating units. Most generally polymers include copolymers which may in turn include random or block copolymers. Specifically, “polymer” includes oligomers (molecules having from 2-10 repeating units). Polymers formed using the disclosure have varying degrees of polymerization (number of monomer units attached together), for example from 2-10; 11-25; 26-100; 101-250; 251-500; 501-750; 751-1000; 1,000-2,000; and even larger; and all individual values and ranges and sub-ranges therein, and other degrees of polymerization. As known in the art, the degree of polymerization can be modified by changing polymerizing conditions.

As known in the art, there are different measures of molecular weight of polymers: average molecular weight (M_{w}, the weight-average molecular weight, or Mₙ, the number-average molecular weight) and molecular weight distribution (M_{w}/Mₙ, a measure of polydispersity because M_{w} emphasizes the heavier chains, while Mₙ emphasizes the lighter ones). The number average molecular weight is the average of the molecular weights of the individual polymers in a sample. The number average molecular weight is determined by measuring the molecular weight of n polymer molecules, summing the weights, and dividing by n. The weight average molecular weight (M_{w}) is calculated by

$${\overline{M}}_{w} = \frac{{\sum }_{i} {N}_{i} {M}_{i}^{2}}{{\sum }_{i} {N}_{i} {M}_{i}}$$

where Nᵢ is the number of molecules of molecular weight Mᵢ. The polydispersity index (PD) is a measure of the distribution of molecular weights of the polymer is the weight average molecular weight divided by the number average molecular weight. As the chains approach uniform chain length, the PDI approaches 1. The degree of polymerization is the total molecular weight of the polymer divided by the molecular weight of the monomer and is a measure of the number of repeat units in an average polymer chain. As described elsewhere herein, the average molecular weights of the polymers produced can vary, depending on the polymerizing conditions, and other factors, as known in the art.

As used herein, “initiators” are those substances which act spontaneously or can be activated with light or heat to initiate polymerization of the alkene monomer. Examples of initiators include azide radical initiators. Some initiators are activated by irradiation with light. Light used in the disclosure includes any wavelength and power capable of initiating polymerization. Preferred wavelengths of light include ultraviolet or visible. Any suitable source may be used, including laser sources. The source may be broadband or narrowband, or a combination. The light source may provide continuous or pulsed light during the process.

As used herein, “polymerizing conditions” are the temperature, pressure and the presence of an initiator that result in a detectable amount of polymer formation. Useful temperatures for polymerization are easily determined by one of ordinary skill in the art without undue experimentation in further view of the description herein. Ambient temperature may be used. In industrial use, a temperature of between about 50° C. and 100° C. is particularly useful since reaction heat can be removed easily. One example of polymerizing conditions is a temperature below the temperature at which the initiator ordinarily decomposes. Useful pressures for polymerization are readily determined by one of ordinary skill in the art without undue experimentation in further view of descriptions herein. Ambient atmospheric pressure may be used. It is known that polymerizing conditions can vary depending on the desired product. Any combination of pressure and temperature which produce a detectable amount of polymer can be used in the methods described here.

According to the present disclosure, a polymerization process is described for conducting polymerization of monomers, particularly “living” polymerization of alkenes, wherein a unique initiator, i.e., azide radical initiator, is provided for producing oligomers and polymers with controlled structure. In the context of the present disclosure, the term “living” refers to the ability to produce a product having one or more properties which are reasonably close to their predicted value. The polymerization is said to be “living” if the resulting number average molecular weight is close to the predicted molecular weight based on the ratio of the concentration of the consumed monomer to the initiator; e.g., within an order of magnitude, preferably within a factor of five, more preferably within a factor of 3, and most preferably within a factor of two, and to produce a product having narrow molecular weight distribution as defined by the ratio of weight average molecular weight to number molecular weight (MWD); e.g., less than 10, preferably less than 2, more preferably less than 1.5, most preferably less than 1.3.

The azide radical N₃., can be easily be generated by the reaction of commercially available, inexpensive oxidants such as hypervalent iodides, cerium ammonium nitrate (CAN) or transition metal oxidants (e.g. FeCl₃, etc) with organic (R—N₃ e.g. as trimethylsilyl azide (CH₃)₃Si—N₃, TMS-N₃)) or inorganic (Mt(N₃)ₙMt═K, Na etc.) azides. Such reactions can be carried out over a wide range of temperatures, solvents and other reaction conditions, including in the presence and in the absence of irradiation with visible or UV light.

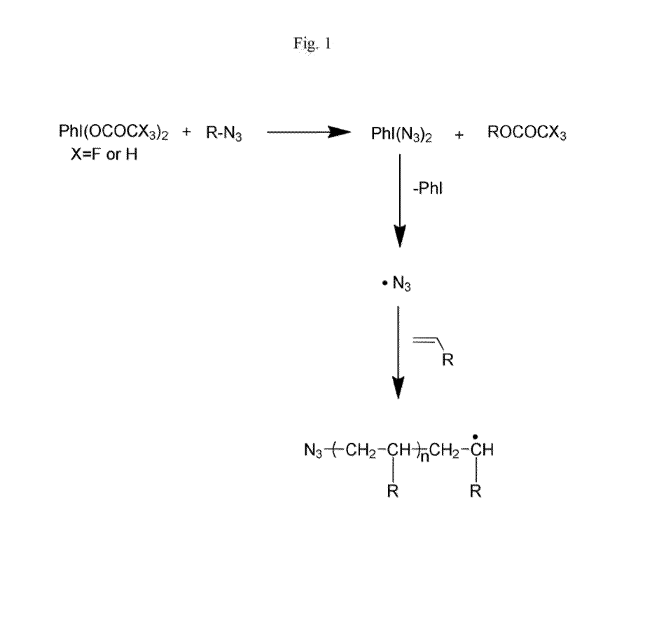

In accordance with this disclosure, azide (N₃) radicals can be generated using hypervalent iodide (HVI) compounds, with hypervalent iodide carboxylates exemplified herein. The azide (N₃) radical generation can occur by hypervalent iodide photolysis or thermolysis or redox reaction with the azide compound. The azide (N₃) radical can also be generated using HVI/NaN₃ at room temperature (see FIG. 1). As depicted in FIG. 1, the first step in the mechanism is the exchange of the carboxylate groups with the N₃ anion, followed by the visible light photolysis or thermolysis of the very weak I—N bonds to generate N₃. Since such reactive radicals initiate vinylidene fluoride (VDF), they can initiate all other conventional monomers and can be used as universal room temperature photoinitiators.

While the addition of N₃. onto polymerizable alkenes can be thus used to initiate a radical polymerization, the addition of N₃. to unsaturations located on polymer chains (such as the azidation of poly(dienes) like polyisoprene or polybutadiene and their copolymers) can be used to perform polymeric polyazidations. The azidation reaction of polydienes and their copolymers can occur for example by photolyzing the polymer in the presence of a hypervalent iodide carboxylate and NaN₃. Alternatively, in the presence of excess HVI or of a free radical initiator, labile H on polymeric backbones can be abstracted and the polymeric radicals can be capped by N₃. In both cases, a persistent radical (nitroxide or CuBr₂/bpy) can be used to prevent possible crosslinking. Such polymeric N₃. reactions can provide access to unique polymer structures, otherwise synthetically inaccessible due to the unavailability of the corresponding monomers.

In accordance with this disclosure, any substrate which is susceptible to radical reaction either by addition or substitution, can be azidated with the procedures described herein. Such substrates include but are not limited to any alkyl halide, any alkane, alkene, alkyne, aromatics, including condensed systems such as graphene, graphene oxide or carbon nanotubes and combinations thereof.

In accordance with this disclosure, control radical polymerization (CRP) can occur following N₃. initiation. To obtain a CRP process, a controlling agent is added, and while for other monomers, nitroxides or CuBr₂, or reversible addition-fragmentation (RAFT) reagents suffices, the only viable method for VDF is iodine degenerative transfer (IDT). Several sources of iodine, including I₂, R—I and R_{F}—I in a metal free organocatalysis, can be used in CRP in accordance with this disclosure.

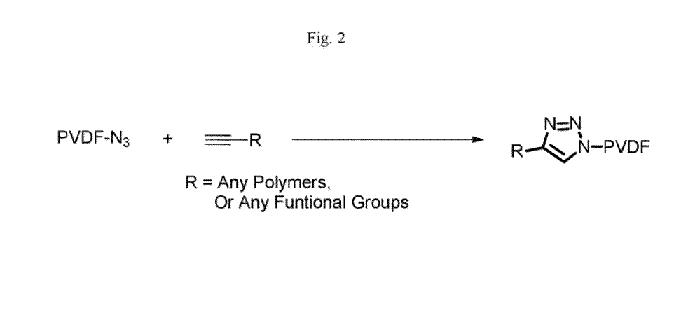

In accordance with this disclosure, complex PVDF structures can be synthesized using Click chemistry. In free radical VDF polymerization in the absence of an iodine chain transfer agent, VDF terminates exclusively by coupling, thus providing a difunctional N₃-PVDF-N₃ polymer, which can be utilized in the synthesis of A-B-A type triblock copolymers. In VDF IDT polymerizations, the clean synthesis of pure, well-defined PVDF blocks from the iodine chain ends requires complete activation of all PVDF-I chain ends, especially ˜CF₂CH₂—I, and this can be accomplished by transition metal catalysis. However, in VDF-IDT polymerizations initiated with azide radicals, the product is N₃-PVDF-I. Thus, one chain (N₃) end can be activated in a Click-type coupling reaction, whereas the iodine chain end can be activated in a radical reaction, to synthesize A-B-C type triblock copolymers. (See FIG. 2). As such, I-PVDF-N₃ can be employed in the synthesis of very complex fluoropolymer architectures using Click chemistry.

In accordance with this disclosure, N₃. radicals can be generated at room temperature in both photo and redox processes. Such reactive N₃. radicals add to alkenes, including, VDF thereby initiating polymerization. Moreover, they are universal initiators, i.e., they will add to and initiate all radically polymerizable alkenes (including very reactive alkenes such as VDF and ethylene). This disclosure also provides conditions under which the polymerization can become a CRP. Azide coupling reactions for PVDF-N₃ and N₃-PVDF-N₃ can occur in a large variety of syntheses of architecturally complex fluorinated architectures (blocks, grafts, stars etc.).

The azide radical initiators useful in this disclosure can be generated from the reaction of an azide compound (e.g., sodium azide, trimethylsilyl azide) with a hypervalent iodide compound or cerium ammonium nitrate or other metal oxidants (FeCl₃, KMnO₄, OsO₄, etc.). Suitable hypervalent iodide compounds are classified based on the number of carbon ligands on the central iodine. Iodinanes include 1C bonds (iodosyl/iodoso compounds (RIO) and their derivatives (RIX₂ where X is non-carbon ligand and R is aryl or CF₃), 2C bonds (iodonium salts (R₂I⁺X⁻), and 3C bonds (iodanes with 3 C—I bonds are thermally unstable and not synthetically useful). Periodinanes include 1C bond (iodyl/iodoxy compounds (RIO₂) and their derivatives (RIX₄ or RIX₂O), and 2C bonds (iodyl salts (R₂IO⁺X⁻). An illustrative periodinane is Dess-Martin periodinane (1,1,1-triacetoxy-1,1-dihydro-1,2-benziodoxol-3(1H)-one).

Other illustrative hypervalent iodide compounds useful for reaction with an azide compound in accordance with this disclosure include compounds with more than one formal carbon bond to iodine. Such compounds include alkenyliodonium (PhI⁺C═CHR X⁻) and alkynyliodonium (PhI⁺C≡CHR X⁻) salts, and iodonium ylides (PhI═CXY where X and Y are electron acceptors).

Cyclic iodinanes are hypervalent iodide compounds useful for reaction with an azide compound in accordance with this disclosure. Such compounds include λ³-iodinanes (benziodoxazoles based on o-iodosobenzoic acid) and λ⁵-iodinanes (benziodoxazoles based on o-iodoxybenzoic acid). An illustrative cyclic iodinane is Dess-Martin periodinane (1,1,1-triacetoxy-1,1-dihydro-1,2-benziodoxol-3(1H)-one). Other illustrative hypervalent iodide compounds include acyloxyiodobenzenes such as (CX₃COO)₂I^{III}Ph, (X═H, IDAB; X═F, IFAB).

μ-Oxo-bridged iodanes are hypervalent iodide compounds useful for reaction with an azide compound in accordance with this disclosure. Such compounds include PhI═(X)OI(X)Ph where X is OTf, ClO₄, BF₄, PF₆ or SbF₆.

The azide radical initiators useful in this disclosure include, for example, those initiators prepared from the reaction of sodium azide with [bis(trifluoroacetoxy)iodo]benzene, [bis(trifluoroacetoxy)iodo]pentalluorobenzene, [bis(acetoxy)iodo]benzene, or the Dess-Martin periodinane (1,1,1-triacetoxy-1,1-dihydro-1,2-benziodoxol-3(1H)-one). The amount of azide radical initiator useful in the process of this disclosure is dependent on the amount of polymerizable monomer or monomers used. The polymerizable monomer or monomers can be used in a total amount of generally from 3-20,000 moles, preferably 5-2,000 moles, more preferably 10-1,000 moles per mole of the azide radical initiator.

This disclosure is not intended to be limited in any manner by the permissible oxidants and reducing agents (i.e. azide sources) useful in the processes described and claimed herein.

Illustrative iodine sources useful in the process of IDT of this disclosure include, for example, I₂, CHI₃, CI₄, GeI₄, PbI₄, and the like. The radical generated from the iodine source should not initiate vinylidene fluoride (VDF). The iodine sources can be used in amounts sufficient to provide a controlled polymerization (i.e., that is the amount of iodine should trap all the radicals generated).

In the present disclosure, polymers with various specifically desired structures and architectures can be purposely produced. In terms of topology, such structures and architectures may include linear, star, comb, hyperbranched, dendritic, cyclic, network, and the like. In terms of sequence/composition distribution such structures and architectures may include homopolymer, random copolymer, block copolymer, graft copolymer, gradient copolymer, tapered copolymer, periodic copolymer, alternating copolymer, and the like.

In the present disclosure, any alkene monomers that are radically polymerizable or copolymerizable can be polymerized and/or copolymerized in the presence of the azide radical initiator. Illustrative alkene monomers include, for example, ethylene, propylene, 1-butene, 3-methyl-1-butene, 1-pentene, 2-methyl-1-pentene, 4-methyl-1-pentene, 1-hexene, 1-heptene, 1-octene, 2-methyl-1-octene, 2-ethyl-1-hexene, 5-methyl-1-heptene, 1-nonene, 1-decene, 1-undecene, 1-dodecene, 2-methyl-1-dodecene, 1-tetradecene, 2-methyl-1-tetradecene, 1-hexadecene, 2-methyl-1-hexadecene, 5-methyl-1-hexadecene, 1-octadecene, 2-methyl-1-octadecene, 1-eicosene, 2-methyl-1-eicosene, 1-docosene, 1-tetracosene, 1-hexacosene, vinylcyclohexane and 2-phenyl-1-butene, although the present disclosure is in no way limited to these examples. The alkene monomers to be polymerized by the process of the present disclosure may be linear or branched and may also contain a cycloaliphatic or aromatic ring structure. These monomers can be used singly or as admixture of two or more than two.

In a preferred embodiment, the alkene monomers are fluorine substituted alkene monomers. Illustrative fluorine substituted alkene monomers include, for example, vinylidene fluoride (VDF), hexafluoropropene, tetrafluoroethylene, trifluorochloroethylene, CF₂═CCl₂, CH₂═CFCl, CF₂═CFX (where X is Cl or Br), CH₂═CX₂ (where X is F, Cl or Br), and CH₂═CHX (where X is F, Cl or Br). These monomers can be used singly or as admixture of two or more than two. Suitable alkene monomers include any permutation of alkenes with halides, e.g., halogenated alkenes having the formula CH₂—CHX, CH₂—CX₂, CHX═CY₂, CHX═CYX, CX₂=CY₂, and CXY═CY₂ (where X and Y are independently F, Cl, Br, or I).

In accordance with this disclosure, other monomers, e.g., vinyl monomers, can be polymerized and/or copolymerized in the presence of the azide radical initiator. Examples of the monomers include but not limited to: carboxyl group-containing unsaturated monomers such as acrylic acid, methacrylic acid, crotonic acid, itaconic acid, maleic acid, fumaric acid, and the like (preferably methacrylic acid), C₂₋₈ hydroxyl alkyl esters of (meth)acrylic acid (preferably methacrylic acid) such as 2-hydroxylethyl (meth)acrylate, 2-hydroxylpropyl (meth)acrylate, 3-hydroxypropyl (meth)acrylate, hydroxybutyl (meth)acrylate and the like, monoesters between a polyether polyol (e.g., polyethylene glycol, polypropylene glycol or polybutylene glycol) and an unsaturated carboxylic acid (preferably methacrylic acid); monoethers between a polyether polyol (e.g., polyethylene glycol, polypropylene glycol or polybutylene glycol) and a hydroxyl group-containing unsaturated monomers (e.g., 2-hydroxyl methacrylate); adducts between an unsaturated carboxylic acid and a monoepoxy compound; adducts between glycidyl (meth)acrylates (preferably methacrylate) and a monobasic acid (e.g., acetic acid, propionic acid, p-t-butylbenzonic acid or a fatty acid).

Other monomers include, for example, monoesters or diesters between an acid anhydride group-containing unsaturated compounds (e.g., maleic anhydride or iraconic anhydride) and a glycol (e.g. ethylene glycol, 1,6-hexanediol or neopentyl glycol); chlorine-, bromine-, fluorine-, and hydroxyl group containing monomers such as 3-chloro-2-hydroxylpropyl (meth)acrylate (preferably methacrylate) and the like; C₁₋₂₄ alkyl esters or cycloalkyl esters of (meth)acrylic acid (preferably methacrylic acid), such as methyl methacrylate, ethyl methacrylate, propyl methacrylate, isopropyl methacrylate, n-, sec-, or t-butyl methacrylate, hexyl methacrylate. 2-ethylhexyl methacrylate, octylmethacrylate, decyl methacrylate, lauryl methacrylate, stearyl methacrylate, cyclohexyl methacrylate and the like, C₂₋₁₈ alkoxyalkyl esters of (meth)acrylic acid (preferably methacrylic acid), such as methoxybutyl methacrylate, methoxyethyl methacrylate, ethoxyethyl methacrylate, ethoxybutyl methacrylate and the like; olefins or diene compounds such as ethylene, propylene, butylene, isobutene, isoprene, chloropropene, fluorine containing olefins, vinyl chloride, and the like.

Still other monomers include, for example, ring-containing unsaturated monomers such as styrene and o-, m-, p-substitution products thereof such as N,N-dimethylaminostyrene, aminostyrene, hydroxystyrene, t-butylstyrene, carboxystyrene and the like, a-methyl styrene, phenyl (meth)acrylates, nitro-containing alkyl (meth)acrylates such as N,N-dimethyl-aminoethyl methacrylate, N-t-butylaminoethyl methacrylate; 2-(dimethylamino)ethyl methacrylate, methyl chloride quaternized salt, and the like; polymerizable amides such as (meth)acrylamide, N-methyl(meth)acrylamide, 2-acryloamido-2-methyl-1-propanesulfonic acid, and the like; nitrogen-containing monomers such as 2-, 4-vinyl pyridines, 1-vinyl-2-pyrrolidone, (meth)acrylonitrile, and the like; glycidyl group-containing vinyl monomers such as glycidyl (meth)acrylates and the like, vinyl ethers, vinyl acetate, and cyclic monomers such as methyl 1,1-bicyclobutanecarboxylate. These monomers can be used singly or as admixture of two or more than two.

The unsaturated monomers useful in this disclosure may homopolymerize or copolymerize. Fluorine substituted unsaturated monomers, e.g., fluorine substituted alkene, acrylic acid and styrene derivatives, and vinyl ether monomers, are useful in this disclosure. Suitable unsaturated monomers useful in this disclosure include, for example, any permutation of alkenes with halides as well as fluorinated acrylates, styrenes, vinyl ethers, and the like.

The polymerizable monomer or monomers can be used in a total amount of generally from 3-20,000 moles, preferably 5-2,000 moles, more preferably 10-1,000 moles per mole of the azide radical initiator. In an embodiment, the polymerizable monomer or monomers can be used in a total amount of from 1 to about 10,000 moles per mole of the azide radical initiator. The molecular weight distribution of resultant polymer (defined by the ratio of weight average molecular weight to number average molecular weight) obtained from processes of the present disclosure is generally from 1.01 to 30, mostly from 1.05 to 3.0, and more preferably less than 2.0.

Various organic or inorganic functional groups can be introduced to the ends of formed polymer or copolymer. By definition, a functional group is a moiety attached to a molecule that performs a function in terms of the reactivity and/or the physical properties of the molecule bearing it. Example of functional groups include but not limited to: halogens (e.g., Cl, Br, I), hydroxyl (—OH) groups such as —CH₂OH, —C(CH₃)₂OH, —CH(OH)CH₃, phenol and the like, thiol (—SH) groups, aldehyde (—CHO) and ketone (>C═O) groups, amine (—NH₂) groups, carboxylic acid and salt (—COOM) (M is H, alkali metal or ammonium), sulfonic acid and salt (—SO₃M) (M is H, alkali metal or ammonium), amide (—CONH₂), crown and kryptand, substituted amine (—NR₂) (R is H or C₁₋₁₈ alkyl), —C═CR′, —CH═CHR′(R′ is H or alkyl or aryl or alkaryl or aralkyl or combinations thereof), —COX (X is halogen), —CH: N(SiR′₃)₂, —Si(OR′)₃, —CN, —CH₂ NHCHO, —B(OR)₂, —SO₂ Cl, —N₃, —MgX. Functionalized polymer and copolymers including macromonomer prepared in accordance with the disclosure may be obtained by two ways: (a) one-pot synthesis using functional initiator; (b) transformation of living or preformed polymer to a desirable functional group by known organic reactions.

Various polymerization technologies can be used to make the polymer, which include but not limited to: bulk polymerization, solution polymerization, emulsion polymerization, suspension polymerization, dispersion polymerization, precipitation polymerization, template polymerization, micro-emulsion polymerization. The polymerization will work with any radically polymerizable monomer. Various solvents can be used in the polymerization. Examples of the solvents are but not limited to: carbonates, e.g., dimethyl carbonate (DMC), acetonitrile, water, aliphatic solvent, aromatic solvent, hetero-atom containing solvent, supercritical solvent (such as CO₂), and the like. The inventive process can typically be conducted between −80° C. and 280° C., preferably between 0° C. and 180° C., more preferably between 20° C. and 150° C., most preferably between 20° C. and 130° C. The inventive process can be conducted under a pressure from 0.1 to 50,000 kPa, preferably from 1 to 1,000 kPa. The addition order of various ingredients in according with the process of the disclosure can vary and generally do not affect the outcome of the living polymerization. Depending the expected molecular weight and other factors, polymerization time may vary from 10 seconds to 100 hours, preferably from 1 minute to 48 hours, more preferably from 10 minutes to 24 hours, most preferably from 30 minutes to 18 hours. The polymerization procedure can consist of mixing the desired monomer and the azide radical initiator in predetermined ratios and in appropriate solvents for a given amount of time under visible or UV irradiation.

The final polymer can be used as it is or is further purified, isolated, and stored. Purification and isolation may involve removing residual monomer, solvent, and catalyst. The purification and isolation process may vary. Examples of isolation of polymers include but not limited to precipitation, extraction, filtration, and the like. Final polymer product can also be used without further isolation such as in the form of the latex or emulsion.

Polymers prepared with the inventive process may be useful in a wide variety of applications. The examples of these applications include, but not limited to, adhesives, dispersants, surfactants, emulsifiers, elastomers, coating, painting, thermoplastic elastomers, diagnostic and supporters, engineering resins, ink components, lubricants, polymer blend components, paper additives, biomaterials, water treatment additives, cosmetics components, antistatic agents, food and beverage packaging materials, release compounding agents in pharmaceuticals applications.

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

### EXAMPLES

According to experiments conducted, initiation and propagation reactions occur. There are two possible initiation steps. One possible step is direct initiation from hypervalent initiator. The other possible step is radical polymerization from azide radical. In propagation step, there are two types of propagation structure namely, 1,2-unit and 2,1-unit. Combination with two initiator and two propagation units, provides four possible propagation steps.

Nuclear magnetic resonance (NMR) is an essential tool for analyzing organic material structure. Because PVDF is fluorinated polymer, not only is proton NMR characterized but also fluorine NMR. Comparing between two NMR data, more precise structure information can be obtained.

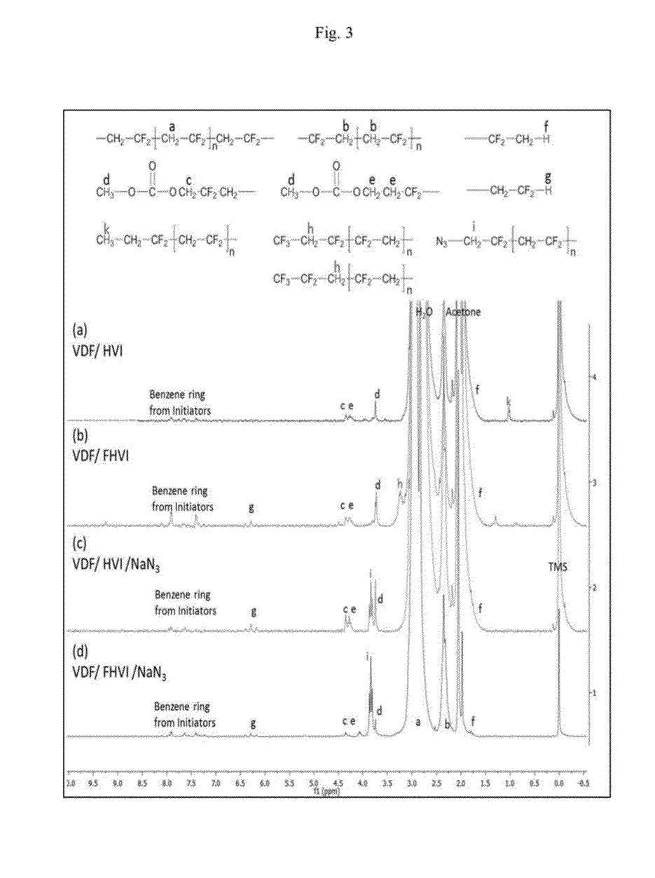

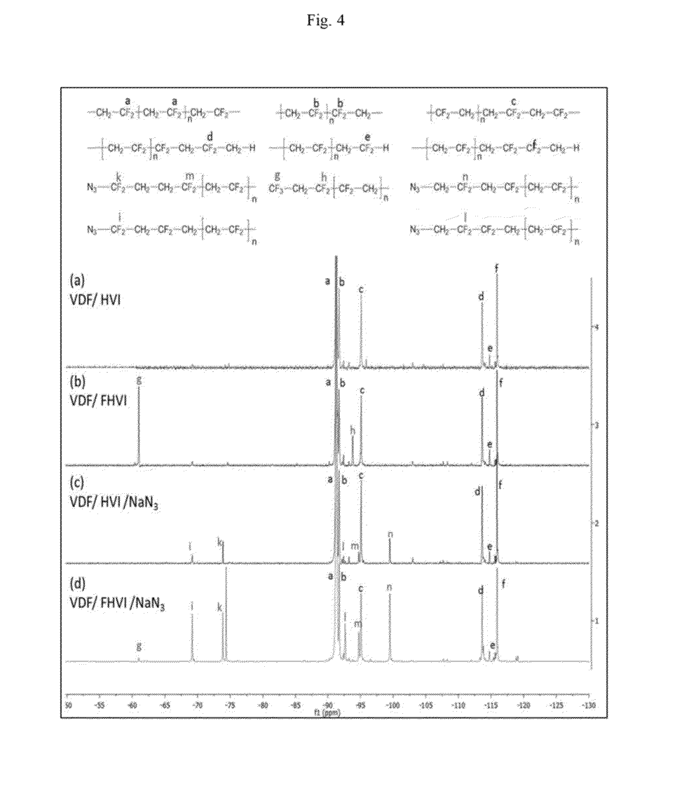

Four polymers are represented for H-, F-NMRs as shown in FIGS. 3 and 4. In each figure, PVDF sample (a) is initiated by HVI monomer only, without sodium azide. PVDF sample (b) is initiated by FHVI monomer only, without sodium azide. (a), (b) are control samples for comparing vs. azide chain ends. PVDF sample (c) is initiated by HVI with sodium azide and sample (d) is initiated by FHVI with sodium azide. Comparing each sample spectrum and crosscheck between H- and F-NMRs, demonstrates that PVDF has azide chain ends.

In FIG. 3, common peaks showed from all 4 samples (labeled as a, b, c, d, e, f). By comparing control samples (a, b), sample (c, d) has azide peak in 3.83 ppm the value is corresponding to reference. In control sample (a) and (b), each spectrum has unique peaks from initiator structure. Sample (a) initiated by CH₃ radical show peak 1.0 ppm (labeled as k) and sample (b) initiated by CF₃ radical show peak 3.23 ppm (labeled as h). Otherwise, sample (c) and (d), the unique peaks are disappeared. It means that chain transfer to azide is very efficient and large population of azide radicals initiate VDF monomers.

FIG. 4 presents the F-NMR spectra of corresponding samples from Proton-NMRs (FIG. 3). By analyzing this spectrum, the regio-structures can be determined more precisely. Analogous to proton NMRs, unique peaks are found from −69.18 ppm and −73.89 ppm (labeled i, k). The peaks from −92.69 ppm, −94.77 ppm and −99.50 ppm (labeled as l, m, n) also closely related with N₃ chain ends. All azide chain ends related peaks possess region-structure information.

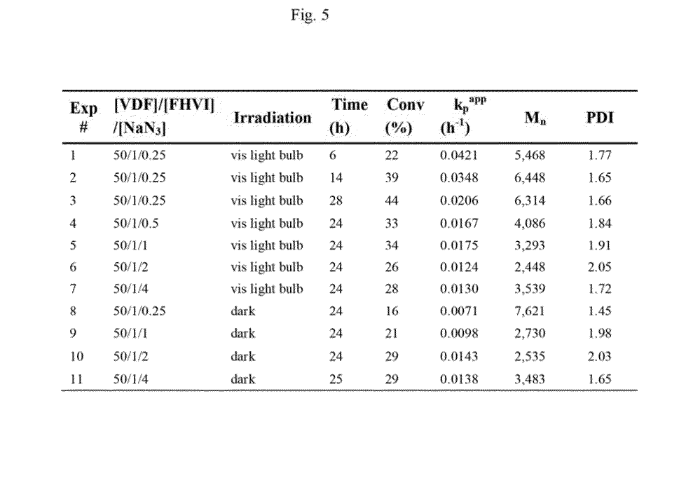

The table in FIG. 5 shows results from an investigation of time effect; Exp. No. 1-3, second, ratio effect between initiator and sodium azide; Exp. No. 3-7, third, the effect of light; Exp. No. 5-11.

With regard to the investigation of the effect of time, [VDF]/[FHVI]/[NaN₃]=50/1/0.25 under vis-light bulb system should be free radical polymerization. Dependence of Mn doesn't show a linear relation on conversion.

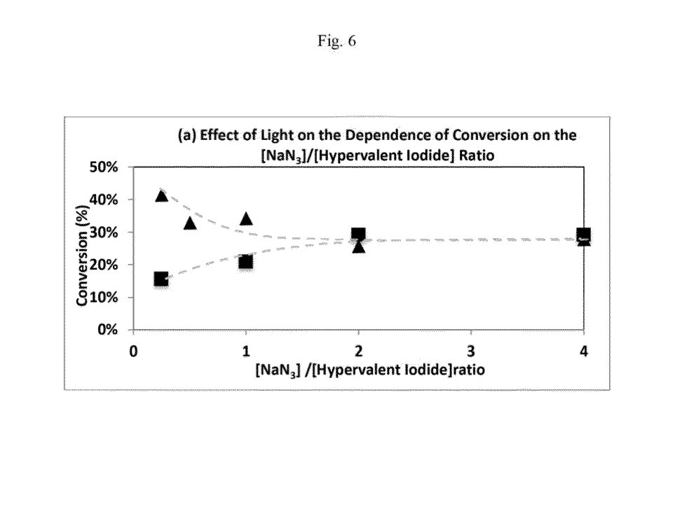

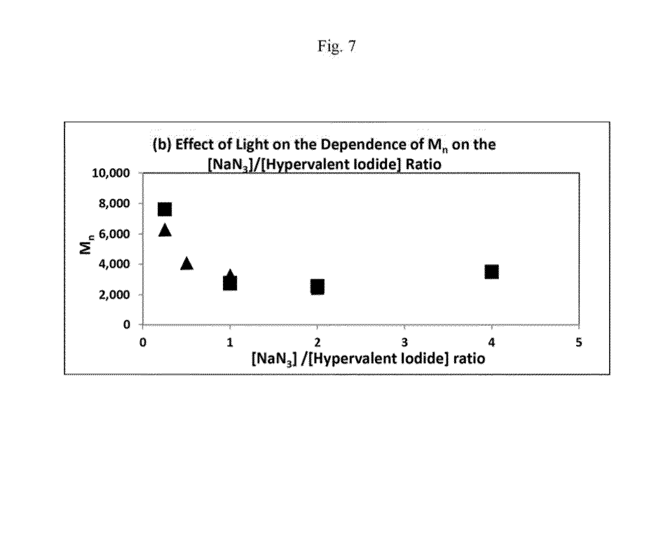

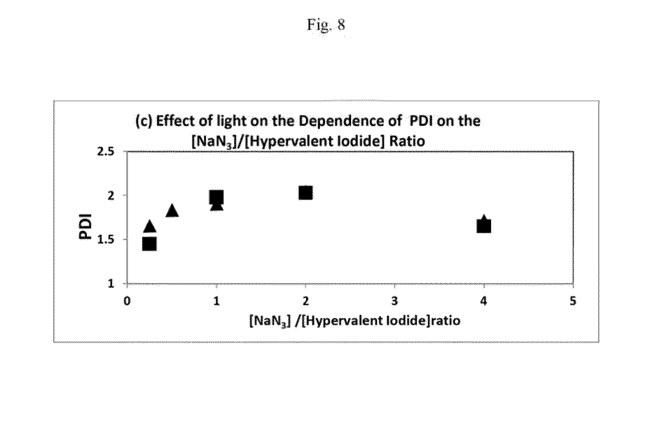

With regard to the investigation of dependence of conversion, Mn, PDI on the [NaN₃]/[Hypervalent Iodine] Ratio, in FIG. 6, conversion showed opposite trend between under light bulb condition and dark condition in [NaN₃]/[Hypervalent Iodine]<2 region. Under light bulb condition, conversion showed decreasing as NaN₃ increasing. On the other hand, in the dark condition, conversion showed increasing as NaN₃ increasing. Mn and PDI showed same trend both under light bulb and dark (see FIGS. 7 and 8).

With regard to the investigation of light bulb effect on chain ends group, CF₃. initiations are for some conditions that [VDF]/[FHVI]/[NaN3]=50/1/0.25 and 50/1/1 under light condition. In the other conditions, excess NaN₃ more than 50/1/2, and every sample in the dark condition doesn't show CF₃. initiations and N₃. initiations are dominant. The N₃. initiation system can be thermally activated at room temperature or below, even without light source. Photolysis is not necessary in this system.

Integration values were calibrated as 1 at azide chain ends hydrogen. Integration value ratio between CF₃-side hydrogen (h) and azide-side hydrogen (i) in Experiment 3 and 5 showed values 1.21, 0.5. The rest showed less than 0.5 values. The data indicates that CF₃ radicals are accelerated by photolysis. On the other hand, in the dark condition or the ratio of [NaN₃]/[FHVI]>2 even under light bulb condition, N₃. initiations become dominant.

Other experiments for azide-enabled polymerization of various monomers, especially VDF, and the conditions necessary to control such polymerization were conducted.

1,6-diiodododecafluorohexane (I—(CF₂)₆—I, 98%), vinylidene fluoride (VDF, 99.9%) (all from Synquest); iodine, I₂ (crystals, resublimed reagent, A.C.S), from EM Science (MCB Reagents); ε-caprolactone (CL, 99%), cerium ammonium nitrate (CAN, 99%), iodoform (CHI₃ 99+%), (from Acros Organics); dimethyl carbonate (DMC, ≧99) % anhydrous), propargyl alcohol (99%), copper(II) sulfate pentahydrate (CuSO₄.5H₂O ACS reagent, ≧98.0%), acetonitrile (ACN, 99%), Tin(II) 2-ethylhexanoate(stannous octoate, (95%), sodium azide (NaN₃, 99%), sodium bicarbonate (ReagentPlus, ≧99.5%), (all from Aldrich); diethylether (anhydrous, 99%), N,N′-dimethylformamide (DMF, 99.9%), L-ascorbic acid (Crystalline/Certified ACS, ≧99.0%), N,N′-dimethylformamide (DMF, 99.9%), (all from Fisher Scientific); acetone-d₆ (Cambridge Isotope Laboratories, Inc., D. 99.9%); tetrahydrofuran (THF, 99%, acetone, 99.9%), (J. T. Baker) were used as received.

¹H NMR (500 MHz) and ¹⁹F-NMR (400 MHz) spectra were recorded on a Bruker DRX-500 and respectively on a Bruker DRX-400 at 24° C. in acetone-d. GPC analyses were performed on a Waters gel permeation chromatograph equipped with a Waters 2414 differential refractometer and a Jordi 2 mixed bed columns setup at 80° C. DMAc (Fisher, 99.9% HPLC grade) was used as eluent at a flow rate of 1 mL/min. Number-average (Mₙ) and weight-average molecular weights (M_{w}) were determined from calibration plots constructed with polymethylmethacrylate standards. All reported polydispersities are those of water precipitated samples. Although MeOH precipitation affords narrower PDIs, it could invariably lead to partial fractionation, especially for lower molecular weight samples. Differential scanning calorimetry (DSC) was performed on a TA Instrument (Q-100 series) calibrated with In and Zn standards.

In a typical reaction, a 35-mL Ace Glass 8648 #15 Ace-Thread pressure tube equipped with a bushing, and plunger valve with two O-rings and containing a magnetic stir bar, CAN, (188 mg, 0.34 mmol) and solvent (e.g. DMC. 3 mL) was degassed with He and placed in a liquid nitrogen bath. The tube was opened and NaN₃ (45 mg, 0.69 mmol) was subsequently added. Finally, VDF (1.1 g, 17 mmol), was condensed directly into the tube, which was then re-degassed with He. The amount of condensed VDF was determined by weighing the closed tube before and after the addition of the monomer. The tube was then placed in behind a plastic shield, in a thermostated oil bath at 40° C., in the dark. For polymerization kinetics, identical reactions were set up simultaneously and stopped at different polymerization times. At the end of the reaction, the tube was carefully placed in liquid nitrogen, slowly opened behind the shield, and allowed to thaw to room temperature in the hood, with the concomitant release of unreacted VDF. The contents were poured in water, filtered and dried. The monomer conversion was determined as the ratio of the differences of the tube weight before and after the reaction and respectively before and alter VDF charging (i.e. c=(Wt_{after VDF condensation}−Wt_{after VDF release})/(Wt_{after VDF condensation}−Wt_{after VDF addition}), as well as the ratio of the dry polymer to the condensed VDF. Both procedures gave conversions within <5% of each other.

In a typical reaction, a tube with CAN, (283 mg, 0.52 mmol) and solvent (e.g. DMC, 3 mL) was degassed with He and placed in a liquid nitrogen bath. The tube was later opened followed by the addition of NaN₃ (67 mg, 1.03 mmol) and I(CF₂)₆I (0.12 mL, 0.52 mmol). Finally, VDF (1.7 g, 26 mmol), was condensed directly into the tube, which was then re-degassed with He. Same technique was followed for the polymerization precipitation and conversion determination.

The tube containing CAN, (283 mg, 0.52 mmol) and solvent (e.g. DMC, 3 mL) was degassed with He and placed in a liquid nitrogen bath. The tube was subsequently opened, NaN₃ (40 mg, 62 mmol) and 12 (26 mg, 0.10 mmol) were added, followed by the condensation of VDF (1.7 g, 26 mmol), directly into the tube, which was then re-degassed with He. Same technique was followed for the polymerization, precipitation and conversion determination.

The synthesis PVDF-b-PCL is described as follows: In a Schlenk tube containing a DMF solution of PVDF-Triazole (90 mg, 0.023 mmol, synthesized from PVDF-N₃ as described in the literatureⁱ), caprolactone (0.50 mL, 4.5 mmol) and Sn(oct)₂ (7 μL, 0.023 mmol) were added and the tube degassed under Ar then heated to 90° C. for 24 h. The solution was precipitated in MeOH, filtered and dried. Mₙ=15,400, PDI=1.49 conv.=67%, and composition, VDF/CL=52/48.

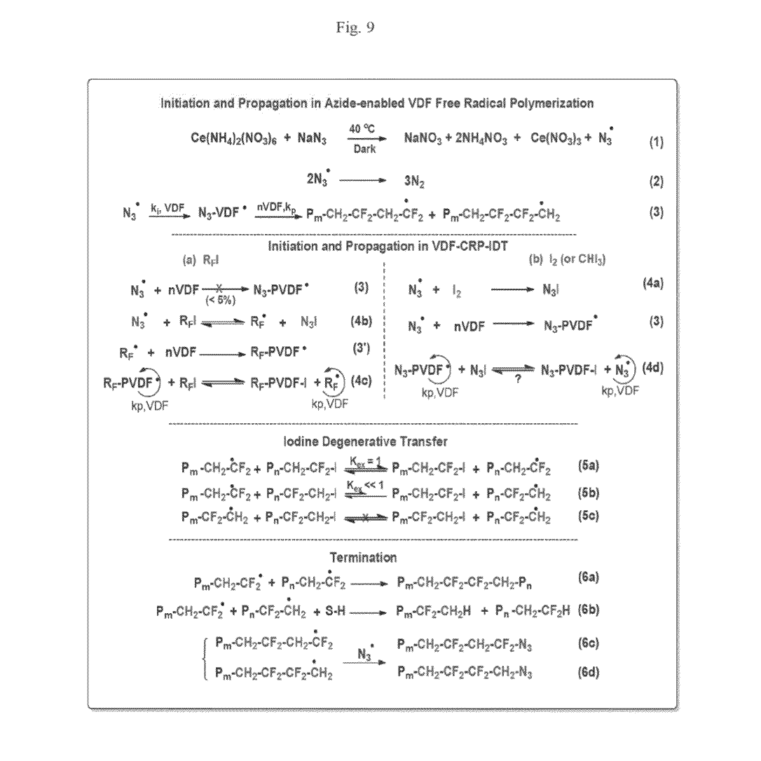

The proposed mechanism for azide-enabled VDF-FRP and VDF-CRP-IDT is presented in FIG. 9. Following its mild generation from the stoichiometric reaction of CAN and NaN₃ at 40° C. in the dark (eq. 1), azide radical could dimerize to give N₂ in the absence of electrophilic substrate (eq. 2). However, in the presence of an alkene (i.e. VDF), initiation of free radical polymerization soon ensue (eq. 3).

To ensure VDF-CRP-IDT, the reaction was carried out in the presence of iodine sources namely I—(CF₂)₆—I and I₂ (or CHI₃). In the VDF-CRP-IDT polymerization with I—(CF₂)₆—I as a CT agent, only a negligible portion (<5%) of the N₃. radicals add directly to VDF, and that >95% of the chains are initiated by R_{F}. (eq. 4b). Thus (at typical IDT ratios (e.g. [R_{F}I]/[HVI]=1/0.1; 0.25; 0.5). Thus df, the polymerization remains colorless, and vast majority of N₃. serves only to abstract iodine from R_{F}—I, generating R^{F}., and respectively, N₃I, a possible excellent IDT mediator.

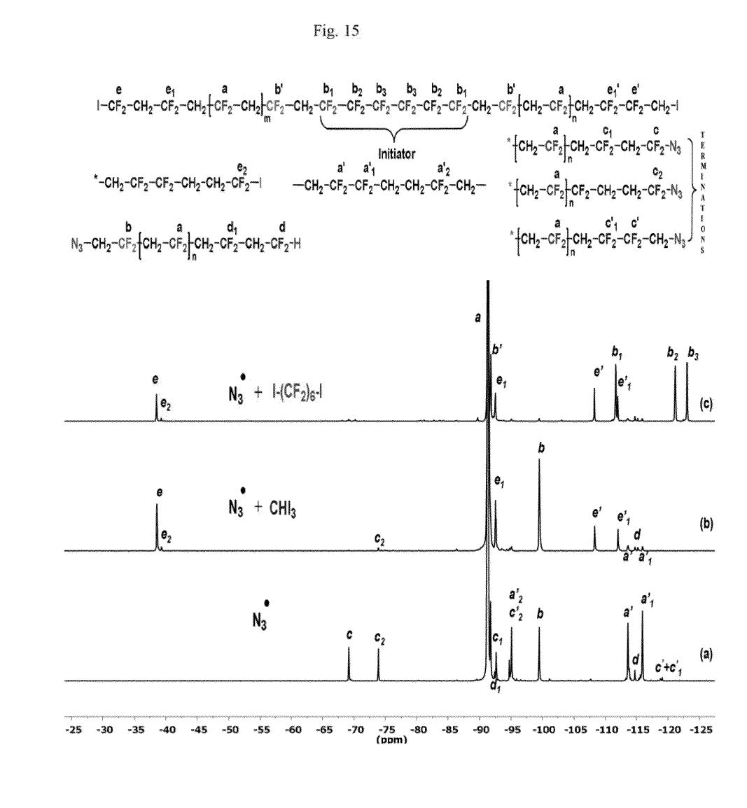

Conversely, using I₂/CHI₃ as iodine source allows for the formation of azide initiated and iodide terminated PVDF chain (FIG. 15). The initial step involves the consumption of I₂ by N₃. to form N₃I (eq. 4a). Once all the iodine is consumed ([N₃.]>[1,2]), the leftover azide radical subsequently add regioselectively on the CH₂ side of VDF.

While chain termination by N₃. radical in azide-enabled VDF-FRP is prevalent, this is however suppressed with the use of iodine sources as the PVDF-CH₂—CF₂. and PVDF-CF₂—CH₂. growing chains are intercepted by iodide to form PVDF-CH₂—CF₂—I and respectively PVDF-CF₂—CH₂—I.

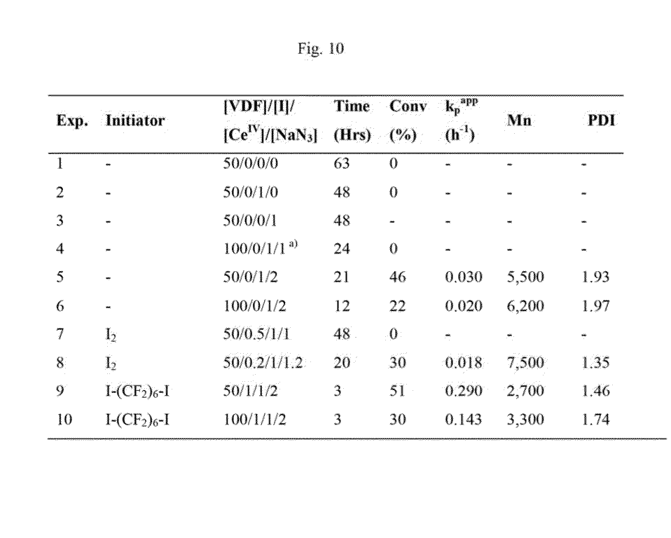

Control experiments (FIG. 10), revealed that VDF alone does not polymerize in the dark at 40° C., CAN or NaN₃ separately does not add to VDF and NaNO₃ does not produce radicals reactive enough to add to VDF.

In the selected solvent effect carried out, DMC showed faster polymerization rate when compared to ACN.

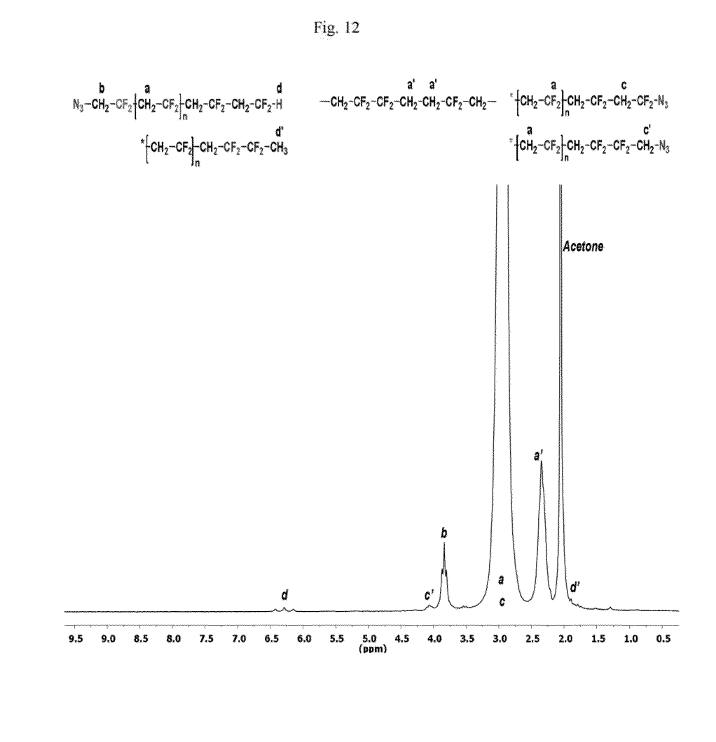

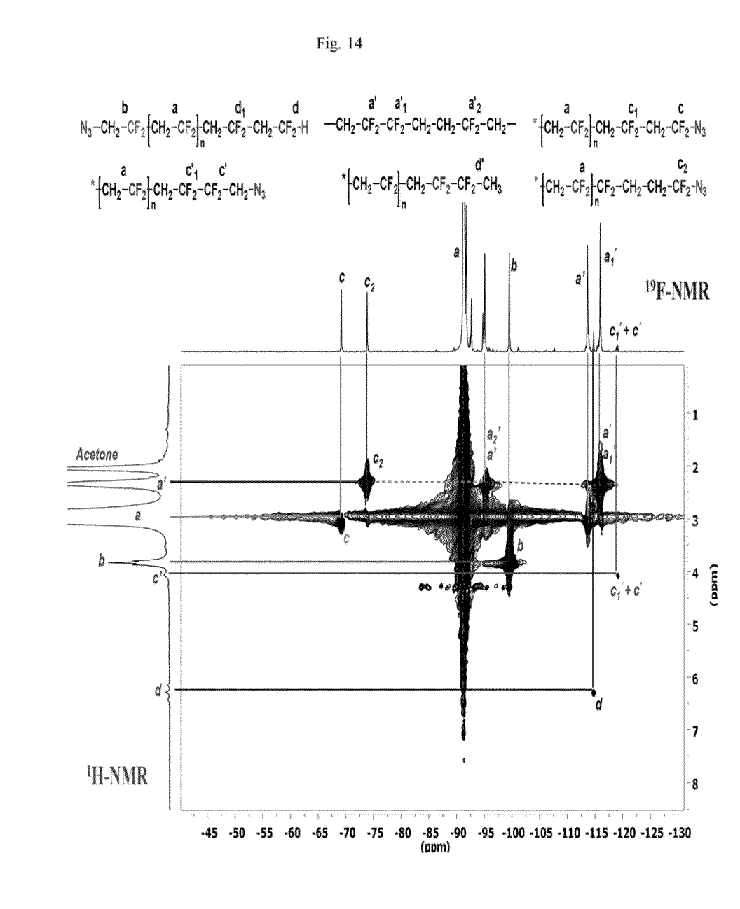

Selected examples of the d-acetone, ¹H-NMR and ¹⁹F-NMR proton decoupled, 2D heteronuclear HF COSY spectra of PVDF obtained in polymerization initiated from azide alone as well as in polymerization in with I—(CF₂)₆—I or I₂ additives are presented in FIGS. 12, 13, 14 and 15. In addition to known PVDF ¹H- and ¹⁹F-NMR resonances, acetone is seen at δ=2.05 ppm. The other sets of signals are associated with azide initiation, PVDF main chain, termination modes, halide chain ends or chain transfer agent. The same notation was use in both ¹H- and ¹⁹F-NMR spectra.

FIGS. 12, 13 and 15 present the 500 MHz ¹H-NMR, 400 MHz ¹⁹F-NMR, and 2D Heteronuclear H, F—COSY (acetone-d6) spectra of PVDF initiated from azide.

Two propagation derived main chain PVDF signals are observed: First, the head to tail (HT), —CF₂—[CH₂—CF₂]ₙ—CH₂—, broad multiplet a, is seen at δ=2.8-3.1 ppm. Next, the head to head (HH) —(CH₂—CF₂)—CF₂—CH₂—CH₂—CF₂—(CH₂—CF₂)ₘ— linkage (typically HH=5-10% in free radical VDF polymerizations) a′ is observed at δ=2.3-2.4 ppm. The resonances derived from PVDF termination by the recombination of terminal HT or HH units partially overlap and cannot be easily identified, as follows: HT/HT (—CH₂—CF₂—CH₂—CF₂—CF₂—CH₂—CF₂—CH₂—, overlap with the HT main chain), HT/HH (—CH₂—CF₂—CH₂—CF₂—CF₂—CF₂—CF₂—CH₂—, identical to HT propagation). As seen later, such termination is dramatically suppressed in the presence of iodine sources, and is visualized by the disappearance of the HH peak a′ which becomes —CF₂—CH₂—I (e′, FIG. 15).

Correspondingly, the main chain PVDF HT —CF₂—[CH₂—CF₂—CH₂—CF₂]ₙ—CH₂— unit a is observed at δ=−91.3 ppm. While the HH units are greatly minimized in VDF-IDT (vide infra), in FRP internal HH are seen as a series of 3 resonances —CH₂—CF₂—CH₂—CF₂—CF₂—CH₂—CH₂—CF₂—CH₂—CF₂—, —CH₂—CF₂—CH₂—CF₂—CF₂—CH₂—CH₂—CF₂—CH₂—CF₂— and —CH₂—CF₂—CH₂—CF₂—CF₂—CH₂—CH₂—CH₂—CH₂—CF₂—, peaks a′, a′₁ and a′₂ at δ=−113.5 ppm, δ=−115.9 ppm and respectively, δ=−95.1 ppm.

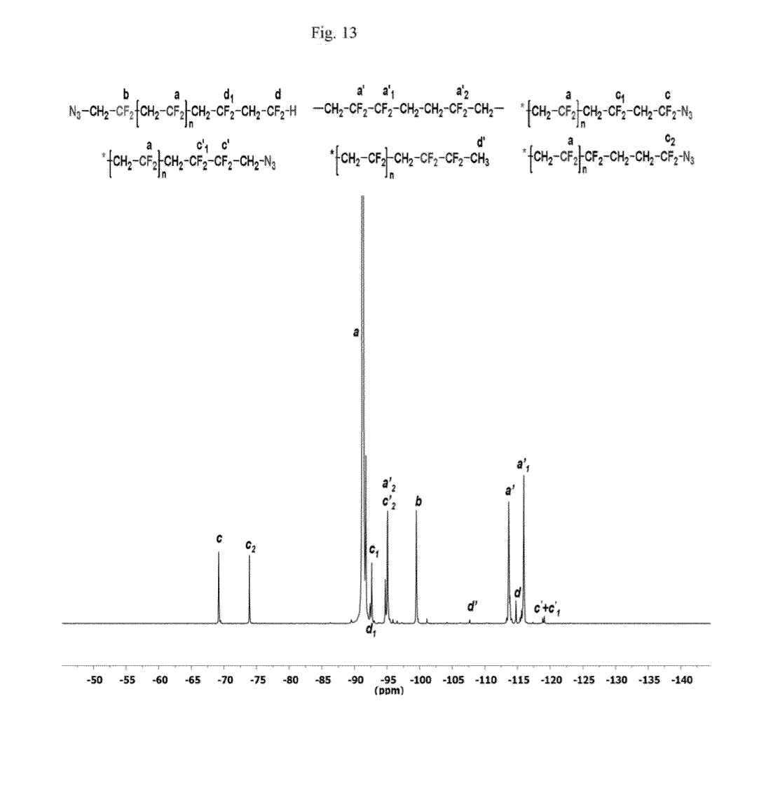

The N₃.-derived initiation is seen via the N₃—CH₂—CF₂-PVDF signal b of the dominant 1,2-addition (t, δ=3.85 ppm, ³J_{HH}=13.9 Hz)Error! Bookmark not defined. The less favored 2,1-addition, as later explained in ¹⁹F-NMR (FIGS. 13, 14 and 15) N³—CF₂—CH₂—CH₂—CF₂— is not observed. Termination by azide radical is also seen as 2,1-type c′, PVDF-CH₂—CF₂—CF₂—CH₂—N₃ at δ=4.08 ppm while the 1,2-c, PVDF-CH₂—CF₂—CH₂—CF₂—N₃ is probably buried under the main peak.

The azide initiation is demonstrated by peak b N₃—CH₂—CF₂—CH₂— δ□=−99.5 ppm. Conversely, the N₃—CF₂—CH₂—CH₂—CF₂— is absent. Terminations by the coupling of the azide radical and growing are observed as c, PVDF-CH₂—CF₂—CH₂—CF₂—N₃, cₜ, PVDF-CH₂—CH₂—CH₂—CF₂—N₃, c₂-CH₂—CF₂—CF₂—CH₂—CH₂—CF₂—N₃, c₁′+c′ PVDF-CH₂—CF₂—CF₂—CH₂—N₃ at δ=−69.2 ppm, δ=−92.7 ppm, δ=−73.9 ppm and respectively δ=−119 ppm.

While dramatically suppressed in IDT, termination may occur by H transfer (from the solvent, or the main chain inter or intramolecular) to the HT ˜CH₂—CF₂., or to a smaller extent, to the HH ˜CF₂—CH₂. propagating units to form —CH₂—CF₂—H (peak d, triplet of triplets at δ=6.3 ppm ₃J_{HH}=4.6 Hz ²J_{HF}=54.7 Hz;) and respectively, —CF₂—CH₃ (peak d′, triplet at 1.80 ppm, ³J_{HF}=19.2 Hz).

¹⁹F-NMR: —CH₂—CF₂—CH₂—CF₂—H d,t, δ=−114.7 ppm, ³J_{HF}=7 Hz; —CH₂—CF₂—CH₂—CF₂H d₁, m, δ=−92.4 ppm, ³J_{HF}=6.2 Hz; as well as —CH₂—CF₂—CF₂—CH₃ d′ m, □δ=−107.6 ppm.

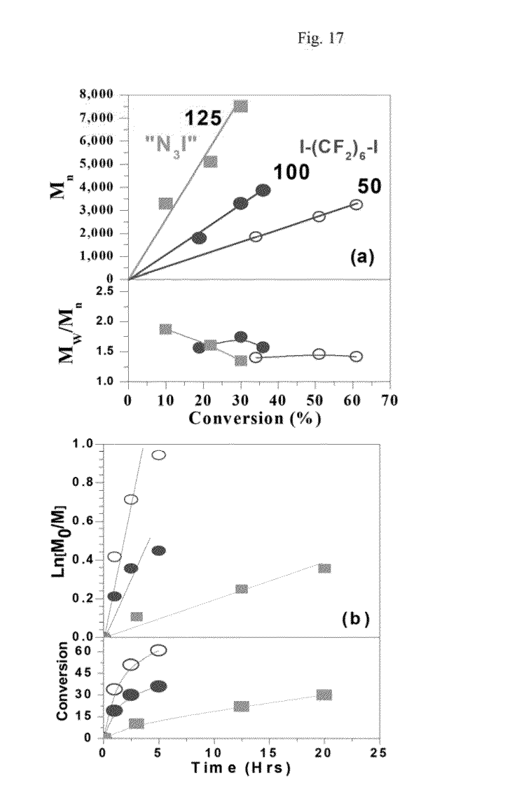

I—(CF₂)₆—I is an excellent CT agent for IDT and this is confirmed by the controlled radical polymerization (FIG. 17) and by the presence of the dominant (>95%)—(CF₂)₆— vs. N₃— initiator chain ends (FIG. 15) i.e. by the absence of resonances associated with the CF₃—CH₂—CF₂—CH₂—CF₂-(IFAB) and CF₃—CH₂—CF₂—CH₂—CF₂-(IDAB, DMPI) connectivity, which confirm that initiation is primarily from I—(CF₂)—I for all HVICs. Here, iodine chain ends (vide infra) are seen in conjunction with greatly diminished termination and HH units.

In the ¹⁹F-NMR, The R_{F} initiator resonances are seen as PVDF-CF₂—CH₂—CF₂—CF₂—CF₂—CF₂—CF₂—CF₂—CH₂—CF₂-PVDF, PVDF-CF₂—CH₂—CF₂—CF₂—CF₂—CF₂—CF₂—CF₂—CH₂—CF₂-PVDF and PVDF-CF₂—CH₂—CF₂—CF₂—CF₂—CF₂—CF₂—CF₂—CH₂—CF₂-PVDF peaks b₁, b₂ and b₃ at δ=−111.7 ppm, δ=−121.2 ppm and δ=−123.1 ppm for I-PVDF-I. The connectivity of the —(CF₂)₆— initiator with PVDF is demonstrated by the resonance b′ (m, δ=−91.8 ppm, ³J_{HF}=9.5 Hz), PVDF-CF₁—CH₂—(CF₂)₆—CH₂—CF-PVDF associated with the first VDF unit.

In ¹⁹F-NMR The more reactive 1,2-iodide chain ends are seen as —CH₂—CF₂—CH₂—CF₂—CH₂—C₂—I and —CH₂—CF₂—CH₂—CF₂—CH₂—CF₂—I, peaks e and e₁ at δ=−38.5 ppm and respectively δ=−92.5 ppm, as well as a weaker, c₂, CH₂—CF₂—CF₂—CH₂—CH₂—CF₂—I, seen at δ=−39.3 ppm.

The less reactive 2,1-iodide chain ends are observed as —CH₂—CF₂—CF₂—CH₂—I and —CH₂—CF₂—CF₂—CH₂—I peaks e′ and e′₁ at δ=−108.3 ppm and respectively δ=−112.0 ppm.

Again here, the N₃ PVDF initiation is demonstrated by peak b, N₃—CH₂—CF₂-(t, δ=3.85 ppm, ³J_{HH}=13.9 Hz).

The regiospecific N₃—CH₂—CF₂-PVDF is again seen as peak b, δ□=−99.5 ppm. The iodide chain ends is consistent as described for I—(CF₂)₆—I.

In the absence of an iodine source, controlled polymerization of VDF initiated from azide predictably, become unattainable. Thus, upon kinetic investigations at various VDF/Azide ratios, as expected, only a typical FRP independence of Molecular weight on conversion was observed (FIG. 6.4) in addition to broad PDI.

In order to promote VDF-CRP-IDT, the azide-enabled VDF polymerization was carried out in the presence of an external and in situ generated chain transfer agents (CTAs).

The consumption of I—(CF₂)₆—I lead to the formation of macromolecular I-PVDF-I CTAs (FIG. 9 eq 4c). At this point, the thermodynamically neutral (K_{equil}^{IDT}=1), reversible iodine exchange between equally reactive, dormant and propagating Pₘ—CH₂—CF₂—I and P—CH₂—CF₂. 1,2-units (eq. 5a) is in operation, and enables IDT-CRP. However, VDF-IDT generates two halide chain ends, Pₙ—CH—CF₂—I and Pₘ—CF₂—CH₂—I with vastly different reactivity. Thus, due to the stronger —CH₂—I bond, the cross-IDT of the 1,2- and 2,1-units (FIG. 5, eq. 5b) is shifted towards irreversible accumulation of unreactive 2,1 Pₙ—CF₂—CH₂—I chain ends, the IDT of which (eq. 5c) is kinetically extraneous. These features are also unavoidable in conventional, or Mn₂(CO)₁₀-mediated VDF-IDT and contribute to PDI broadening. As expected, using I—(CF₂)₆—I as an external CT agent, linear dependence of Mₙ on conversion and reasonable polydispersity values (PDI ˜1.5) was obtained (FIG. 17). In addition Mₙ scales with the [VDF]/[I(CF₂)₆I] ratio (e.g. 50, 100) of IFAB vs IDAB vs DMPI at DP for VDF/icf26i/HVI=200/1/x: In this case, an additional effect is seen in PDI. Thus, while after ˜20% conversion the PDI from IDAB and DMPI is −1.4, IFAB leads to PDI ˜1.55. This is due to the fact that while I abstraction by the IDAB and DMPI derived CH₃. produces the CT-inactive CH₃I, IFAB generates IDT active CF₃I which can initiate another PVDF chain. As such, for IDAB and DMPI once all R_{F}I is consumed via CT, no new PVDF-I chains can be generated, as IDAB and DMPI serve simply to activate the PVDF-CH₂—CF₂—I chain ends and generate the inert CH₃I. However, there will still be a continuous supply of new chain ends from IFAB/CF₃I which explains the slightly higher IFAB PDI (which is uncompensated by the available iodine).

So, once all RFI CT agent is consumed, and u have initiated all the PVDF dormant chains, a new CH₃. can either add 2 VDF to give PVDF. or abstract I from the good/bad chain end to also give PVDF. and dead CH₃I, and these two can be in competition. While the same can happen for CF₃., since CF3I is an IDT CT agent, eventually all CF3. end up as new chains, which are no longer compensated by the same nr of iodides as they were for HVI. Thus, while living, the PDI will always be slightly broader for FHVI. So a VDF/RFI/HVI=200/1/0.25, the DP is 200/1, but for FHVI is 200/(1+0−0.5). Thus, by comparison, slightly more chains, uncompensated by a corresponding amount of iodine, are produced under these conditions, leading to a PDI increase. (However, the opposite effect is seen while using I₂, vide infra.).

As mentioned earlier, according to the above sequence of events, 12 merely serves to provide N₃I in situ, and polymerizations where [VDF]/[I₂]/[N₃.]=a/b/c are equivalent with polymerizations where [VDF]/[“N₃I”]/[N₃.]=a/2b/(c−2b). Consequently, unlike VDF-CRP-IDT with I(CF₂)₆—I, all chains are initiated from the azide radical. This however, provides the first examples of azide initiated, iodine terminated VDF polymerization, as confirmed by the NMR (FIG. 15). As such, typical VDF-CRP character is seen by the linear dependence of Mₙ on conversion (FIG. 17) with moderate PDI ˜1.4.

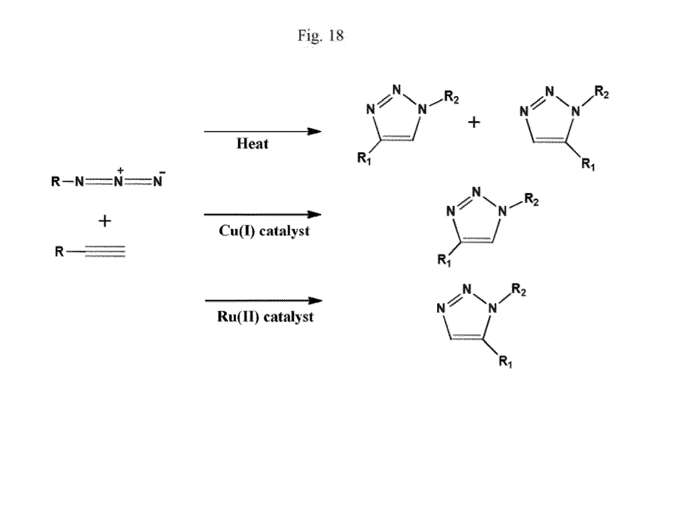

Click chemistry reactions (FIG. 18), have been immensely investigated and well applied in organic synthesis. The scope of which allows for high yield, couplings with almost no limits of functional group tolerance, easy to perform experiments, stereospecific in nature, excludes solvent (bulk) requirement or use of benign solvents, minimal with little or no byproducts.

Recently, click chemistry reaction has become a preferred mode of block copolymer synthesis via the click coupling of the appropriately N₃ and alkyne functionalized segments, with high selectivity and high yield. Thus, for most polymer click couplings, the azide chain ends on one of the participating polymer is typically obtained via an exchange reaction with the halogen chain ends afforded by ATRP, while the alkyne chain end of the coupling partner is achieved from the initiation with acetylene functionalized alkyl halides initiators such as propargyl bromide.

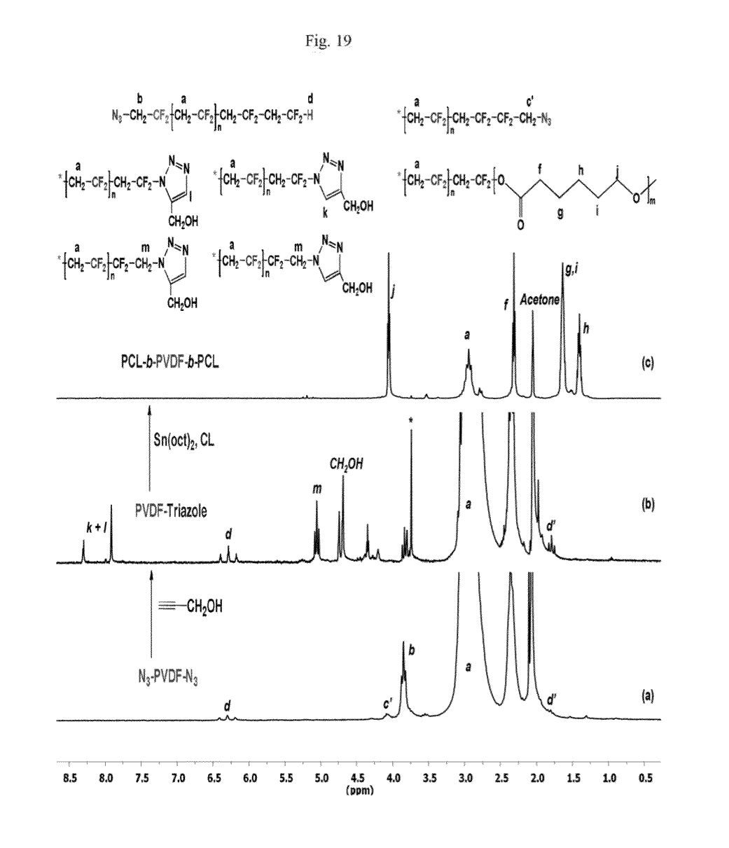

While there is no known azide initiated polymerization, this method of azide radical generation via single electron oxidation of NaN₃ represents the first examples of azide initiated/terminated PVDF (FIGS. 12, 13 and 14). This assertion was also confirmed by the synthesis of triazole-PVDF-triazole directly from N₁-PVDF-N₃ and propargyl alcohol as described in the literature and the subsequent synthesis of PCL-b-PVDF-b-PCL block copolymer (FIG. 19) from the hydroxyl terminated PVDF-triazole and CL.

In addition, GPC traces showed differences in elution time between the starting material and the block copolymer synthesized thereafter. As a further proof, the DSC of heating and cooling cycles of PCL-b-PVDF-b-PCL block copolymer revealed differences in the melting (Tₘ) and crystallization (T_{c}) temperatures of the two polymer segments.

The examples show azide initiated/terminated VDF polymerization. While typical free radical polymerization is obtained with azide radical alone, however, in the presence of external or in situ generated chain transfers agents, VDF-CRP-IDT can be promoted.

The fastest polymerization rate was again obtained using DMC as a solvent.

Azide initiated/terminated PVDF was confirmed following the synthesis of PVDF-triazole and subsequent synthesis of PCL-b-PVDF-b-PCL block copolymers as evident by the NMR, GPC traces and DSC heating and cooling cycles.

All patents and patent applications, test procedures, and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. A process comprising polymerizing at least one unsaturated monomer in the presence of an azide radical initiator and optionally a solvent, under reaction conditions and for a time sufficient to polymerize the at least one unsaturated monomer to form a polymer.

2. The process of claim 1, wherein the at least one unsaturated monomer comprises at least one fluorine substituted alkene monomer, fluorine substituted acrylic acid derivative monomer, fluorine substituted styrene derivative monomer, and/or fluorine substituted vinyl ether monomer.

3. The process of claim 1, wherein the at least one unsaturated monomer comprises vinylidene fluoride (VDF), hexafluoropropene, tetrafluoroethylene, trifluorochloroethylene, CF₂═CCl₂, CH₂═CFCl, CF₂═CFX (where X is Cl or Br), CH₂═CX₂ (where X is F, Cl or Br), CH₂═CHX (where X is F, Cl or Br), CHX═CY₂, CHX═CYX, CX₂=CY₂, and/or CXY═CY₂ (where X and Y are independently F, Cl, Br, or I).

4. The process of claim 1, wherein the at least one unsaturated monomer is used in a total amount of from about 1 to about 10,000 moles per mole of the azide radical initiator.

5. The process of claim 1, wherein the azide radical initiator is generated from the reaction of an azide compound with a hypervalent iodide compound, wherein the azide compound comprises a metal azide or an organic azide and the hypervalent iodide compound comprises [bis(trifluoroacetoxy)iodo]benzene, [bis(trifluoroacetoxy)iodo]pentafluorobenzene, [bis(acetoxy)iodo]benzene, and/or the Dess-Martin periodinane (1,1,1-triacetoxy-1,1-dihydro-1,2-benziodoxol-3(1H)-one).

6. The process of claim 5 wherein the metal azide is sodium azide and the organic azide is trimethylsilyl azide.

7. The process of claim 1, wherein the azide radical initiator is generated from the reaction of an azide compound with and oxidant, wherein the azide compound comprises a metal azide or an organic azide and the oxidant comprises cerium ammonium nitrate, KMnO₇, CAN, FeCl₃ or CuCl₂.

8. The process of claim 1, wherein the azide radical initiator is capable of producing radicals sufficient to initiate polymerization under thermal conditions between below 0° C. and above 100° C., or upon exposure to visible or ultraviolet light.

9. The process of claim 1, wherein the solvent comprises a carbonate or acetonitrile.

10. The process of claim 1, wherein the polymerization is carried out at a temperature between about 0° C. and about 180° C.

11. The process of claim 1, which is a controlled polymerization further carried out in the presence of an iodine source.

12. The process of claim 11, wherein the iodine source comprises I₂, CHI₃, CH₂I₂, CI₄, allyl iodide, NaI, GeI₄ and/or PbI₄.

13. The process of claim 1, wherein the polymer has a molecular weight distribution (defined by the ratio of weight average molecular weight to number average molecular weight) from about 1.01 to about 5.

14. A process comprising polymerizing at least one unsaturated monomer in the presence of an azide radical initiator, a solvent, and an iodine source, under reaction conditions and for a time sufficient to controllably polymerize the at least one unsaturated monomer to form a polymer.

15. The process of claim 14, wherein the iodine source comprises I₂, CHI₃, CI₄, CH₂I₂, allyl iodide, GeI₄ and/or PbI₄.

16. A polymer produced by the process of claim 1.

17. A polymer produced by the process of claim 14.

18. A PVDF polymer where all chains contain at least one N₃ unit.

19. A PVDF polymer where the azide unit is connected via both PVDF-CH2—CF₂—N₃ and PVDF-CF₂—CH—N₃ chain ends.

20. A polymer or copolymer produced by a Click coupling reaction of PVDF-N₃ or N₃-PVDF-N₃ with appropriately alkyne or alkene functionalized substrates, including inorganic, organic or polymer substrates.
